(19) United States
(12) Patent Application Publication
(10) Pub. No.: US 2025/0367576 A1
(43) Pub. Date: Dec. 4, 2025

(54) SET FOR REPLACEMENT OF ENTRANCE BUSHINGS OF DESALTERS IN FLEXIBLE CONDUCTOR WITH BARE RIGID CONDUCTOR IMMERSED IN INSULATING LIQUID

(71) Applicant: PETROLEO BRASILEIRO S.A. - PETROBRAS, Rio de Janeiro (BR)

(72) Inventor: Carlos Eduardo DE MELLO MARCOS, Canoas (BR)

(21) Appl. No.: 19/216,887

(22) Filed: May 23, 2025

(30) Foreign Application Priority Data
May 31, 2024 (BR) 1020240109899

(51) Int. Cl. B01D 17/12; B01D 17/06

(52) U.S. Cl. CPC B01D 17/12; B01D 17/06

(57) ABSTRACT

The present invention refers to a set for replacing entrance bushings of desalters in flexible conductor with bare rigid conductor immersed in insulating liquid. More specifically, this set comprises a transformer entrance bushing subset (15); an interconnecting conductive parts subset (16); a desalter entrance bushing subset (19); and an interconnection piping subset (18). These subsets are integrated to prevent partial discharges from occurring in diameter transition sections between the desalting tubes.

### FIELD OF THE INVENTION

The present invention is part of the technical field of equipment for desalination of oil or similar (electrostatic precipitators) that operate with similar voltage levels (medium voltage) with necessary dimensional adjustments in the replacement of entrance bushings in desalter units that use solid insulation conductor technology.

Thus, the present invention proposes a solution that allows a way to replace the entrance bushings that use flexible conductor with solid insulation, but subject to degradation by partial discharges, by a set that uses a bare rigid metallic conductor, without using solid insulation in the conductor, immersed in insulating liquid inside rigid metallic ducts, maintaining the necessary insulation clearances for the voltage level.

### BACKGROUND OF THE INVENTION

A desalter, in the context of oil and gas is a unit used to remove contaminants and impurities, such as salts dissolved in the water produced during oil extraction. If not treated properly, this water can cause problems such as corrosion in equipment and pipelines, reducing their lifespan and efficiency.

Before crude oil is refined, impurities present need to be removed for several reasons. Solid contaminants can contribute to equipment clogging and scale formation.

During the refining process, the more water that is contained in the crude oil, the greater the amount of heat that needs to be applied to raise the temperature of the oil and water mixture to the temperature required for distillation. Chlorides, one of the types of salts found in crude oil, may be responsible for the formation of hydrochloric acid at the temperatures commonly found in a crude oil distillation tower.

Hydrochloric acid is an extremely corrosive compound. Removing contaminants in crude oil can increase distillation capacity, lower refinery fuel costs, and reduce corrosion and clogging problems. For all these reasons, desalting is the first and one of the most important stages in a refining operation.

One of the biggest challenges faced by desalter units is related to the occurrence of partial discharges in internal areas of the system, where there is a transition between reduced diameters of the metal parts. Partial discharges are electrical phenomena that occur in insulating solids insulators when the strength of the local electric field exceeds the dielectric limit of the material. At these transition points, the concentration of the electric field can increase due to the irregular geometry, resulting in voltage spikes that lead to degradation of solid insulation.

Degradation of solid insulation can have several adverse consequences, including reduced equipment efficiency, increased risk of electrical failures, and even the need for unscheduled downtime for corrective maintenance. In addition, the presence of partial discharges can accelerate the aging process of insulating materials, shortening their lifespan and increasing operation and maintenance costs.

In this sense, the present invention proposes the creation of a set to replace the original entrance bushings which ensures compatibility with the other parts of the desalters (vessel, flanges, transformers, connection with internal grids); maintain electrical insulation even in transition sections with reduced diameters of metal parts, and eliminate the cause of failure (degradation of solid insulation by partial discharges); through the use of a rigid conductor immersed in insulating liquid, which maintains the functionality of the pressure relief system and oil drain in the event of rupture or leakage of the entrance bushing, in addition to allowing the replacement of the entrance bushing without the need to remove insulating oil and open the transformers.

### STATE OF THE ART

Document JPH10204447A describes an entrance bushing mounted on the shell of the desalter through a self-housing compartment, which is equipped with a cylindrical insulator which has an upper opening and a lower opening, and with a conductor which is inserted into the lower opening and fixed to it, so that it can close and seal the lower opening, and which is also used to conduct the voltage from the high-voltage generating transformer to the electrode inside the shell, and which has the annular cross-sectional space formed between the conductor and the insulator filled with insulating oil. The radial dimension of the space between the conductor and the insulator is adjusted to a value between 3 and 85 times the diameter of the bubble that remains in the insulating oil in the direction of the diameter.

However, it should be noted that document JPH10204447A aims to solve the problem of the occurrence of electrical discharges due to the presence of air bubbles in the entrance insulating oil that fills the bushing in the desalting/bushing model. In the system for which the invention is proposed, entrance bushings of a different model are used, in which the connection with the internal electrodes (grids) is made by pressure between the bushing tip and a “spring-plate” system installed in the grid on the inside of the desalter, which allows the exchange of the entrance bushing without cleaning and entering the desalter. In addition, the bushings do not have closure of their internal space at the top, which does not generate the problem of air bubbles trapped in the insulating oil inside the bushings. These characteristics were already present in the original set of the desalter model for which the present invention was developed and was maintained in the invention, with the necessary modifications to allow the use of a bare rigid conductor, without using solid insulation in the conductor, making the transition between the interior of the insulator of the entrance bushing, made of PTFE, and the section where the insulation is provided by the insulating oil of the rigid ducts with an insulation clearance in the oil sufficient for the insulation levels required by the system, which is not described in document JPH10204447A. Without the modifications proposed by the invention, it would not be possible to use the conductor without solid insulation due to the reduced clearances of the openings of the desalter vessel and the transformer where the entrance bushing is mounted.

Document WO2014098501A1 describes a crude oil desalting system that applies high voltages supplied by an electrical transformer to a high-voltage cable and allows a desalter to remove impurities such as moisture and/or salt from the crude oil in the desalter. The crude oil desalting system consists of: a high-voltage side bushing equipped with a jack plug to ensure ease of fixing/disconnecting the high-voltage cable; desalting the side bushing to ensure the durability of the high-voltage cable and prevent the outflow of crude oil in the desalter; and a connecting tube for electrical connection of the high-voltage cable from the electrical transformer to the desalter, so that the high-voltage cable is in an electrically isolated state.

However, document WO2014098501A1 does not describe a set of elements that allow the replacement of the original system of a desalter, which uses a flexible conductor with solid insulation (PTFE or silicone insulated cable) installed in a metallic conduit (flexible or rigid) filled with insulating oil, with the use of a bare rigid conductor (rod) installed immersed in insulating oil in rigid ducts with sufficient spacing so that the insulating oil provides adequate insulation at the operating voltage levels of the system, even with the reduced dimensions of the original project and without the need for changes in the other components of the desalter, such as the vessel or the transformer. To make the solution possible only with the replacement of the entrance bushing components and interconnection up to the transformer, without changes in the shell of the desalter or the transformers, the parts of the set were developed to provide adequate insulation, compatible dimensions, electrical conduction capacity, constructability and maintainability.

Document CN109742625A describes a high-voltage flexible connection device used for an electric dehydration transformer of crude oil and a method for its installation, and addresses the problem of an existing connection device, wherein an external connection pipeline lacks sufficient hardness, or the hardness is too high and the flexibility is weak. The device mainly comprises a high-voltage flexible connection element, wherein the high-voltage flexible connection element comprises a flexible connecting tube with a stainless steel wire and a high-voltage cable; the flexible connecting tube with stainless steel thread is coated with the high-voltage cable; the flexible connecting tube with stainless steel thread is filled with support sheets and insulating sleeves, arranged at gaps; the support sheets and insulating sleeves are coated onto the high-voltage cable; both ends of the flexible connecting tube with stainless steel thread are independently provided with a flange; and the flanges are independently connected to a high-voltage junction box of the transformer and to a high-voltage junction device of the electric dehydration tank through an insulated sealing structure. Through the use of the device, the mechanical and external compressive strength can be guaranteed; the internal distribution of the electric field is equalized and the intensity of the insulation is improved.

However, unlike the present invention, this document indicates that the transformer and the desalter unit are connected by a flexible member, which is precisely the cause of the technical problem solved by the proposed invention.

Thus, it is evident that no state of the art document proposes a set of parts with adequate dimensions, geometries and materials that allows the application of a solution of bare rigid conductors with insulation by means of insulating liquid, in desalters whose original model uses flexible conductors with solid insulation (cables), without the need for structural modifications of great magnitude in the desalter shell and/or in the transformer. In addition, there are no solutions in the state of the art for the problem of failure in the solid insulation of flexible conductors (cables or wires) used for the interconnection between the entrance bushing and the transformer. There are no indications in the state of the art that allow for the replacement of flexible conductors with solid insulation by a bare rigid conductor with insulation provided by insulating liquid.

Thus, the present invention proposes the use of a bare rigid conductor (rod), without solid insulation in the conductor, making the transition between the interior of the insulator of the entrance bushing of the desalter and the transformer bushing, both in PTFE, and the section where the insulation is provided by the insulating oil of the rigid ducts, with a sufficient insulation clearance in the oil to meet the insulation levels required by the system, using a vertical rod connected to the entrance bushing, a horizontal rod connected to the transformer bushing, and a connection between both rods inside the rigid ducts filled with insulating liquid. Without the modifications proposed by the invention, it would not be possible to use the conductor without solid insulation due to the reduced clearances of the openings of the desalter vessel and the transformer where the entrance bushing is mounted.

### SUMMARY OF THE INVENTION

This invention presents a set for replacing the entrance bushings of desalters using a flexible conductor with s bare rigid conductor immersed in insulating liquid. More specifically, this set comprises a subset of transformer entrance bushing; a subset of interconnecting conductive parts; a subset of the desalter entrance bushing; and a subset of interconnecting pipeline.

### BRIEF DESCRIPTION OF THE DRAWINGS

The present invention will be described below with reference to the typical embodiments thereof and with reference to the attached drawings, wherein:

FIG. 1 is a representation of a desalter in which the set of the present invention is applied.

FIG. 2 is a sectional representation of the component subsets of the present invention.

FIG. 3 is a representation of the transformer entrance bushing subset of the present invention.

FIG. 4 is a representation of the subset of interconnecting conductive parts of the present invention.

FIG. 5 is a representation of the subset of the desalter entrance bushing of the present invention.

FIGS. 6A and 6B are representations of the structure for installing the vertical section of the conductors of this invention.

FIG. 7 is a representation of the rigid conductor transition crosshead of the present invention.

FIG. 8 is a representation of the sight glass of the present invention.

FIG. 9 is a representation of the transition structure to the transformer flange of the present invention.

FIG. 10 is a representation of the structure for ventilation and connection of the pressure indicator and the drainage structure of the present invention.

### DETAILED DESCRIPTION OF THE INVENTION

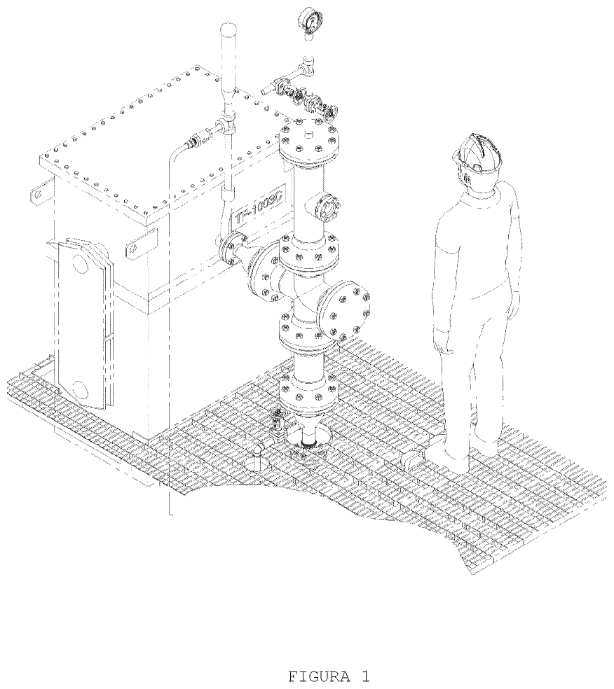

The present invention relates to a set for replacing the original entrance bushing of desalters, as shown in FIG. 1, which ensures compatibility with the other parts of the desalter (vessel, flanges, transformers, connection with internal grids), maintains electrical insulation even in transition sections with reduced diameters of metal parts, and eliminates the cause of failure (degradation of solid insulation due to partial discharges) through the use of a rigid conductor immersed in insulating liquid, ensuring the functionality of the pressure relief system and oil drain in the event of rupture or leakage of the entrance bushing, in addition to allowing the replacement of the entrance bushing without the need to remove insulating oil or open the transformers.

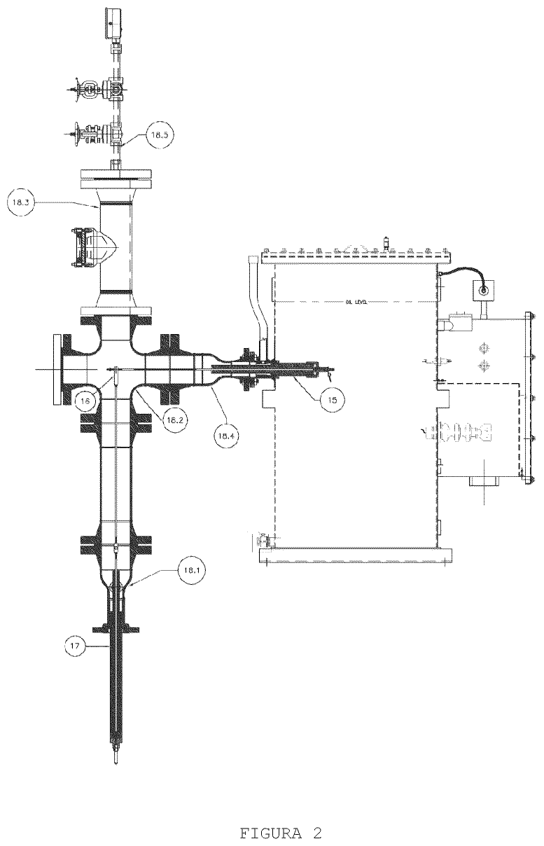

Thus, the invention proposes modifications to allow the use of a bare rigid conductor (rod), without solid insulation on the conductor, making the transition between the interior of the insulator of the entrance bushing of the desalter and the transformer bushing, both in PTFE, and the section where insulation is provided by the insulating oil of the rigid ducts, with a sufficient insulation clearance in the oil to meet the insulation levels required by the system, using a vertical rod connected to the entrance bushing, a horizontal rod connected to the transformer bushing, and a connection between both rods inside the rigid ducts filled with insulating liquid, as can be seen in the cross-sectional drawing of the set presented in FIG. 2, which is generally composed of: a transformer entrance bushing subset (15); an interconnecting conductive parts subset (16); a desalter entrance bushing subset (19); and an interconnection piping subset (18).

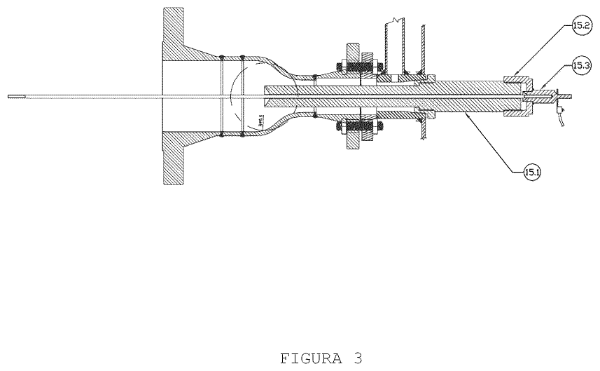

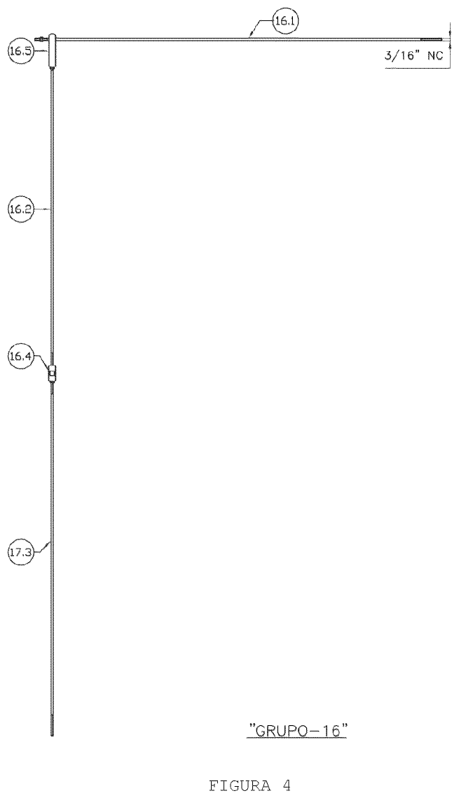

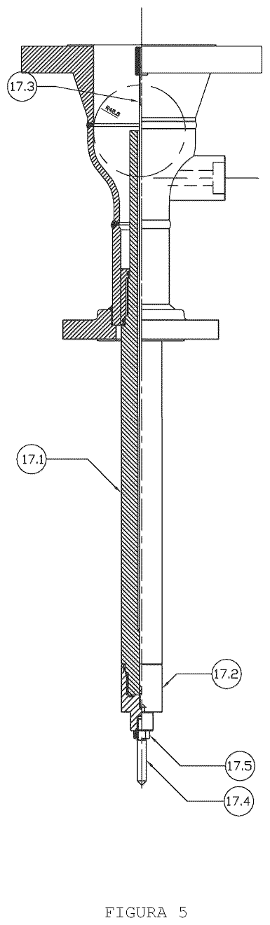

More specifically, the set of this invention consists of the following elements:
a) the transformer entrance bushing subset (15) is composed of parts 15.1, 15.2 and 15.3, as shown in FIG. 3, where the horizontal conductor rod is connected;
b) the interconnecting conductive parts subset (16) comprises two electric conductor rods with adequate ampacity for the nominal current of the transformer secondary winding, one horizontal (16.1) and the other vertical (16.2), a right-angle interconnection connector (16.5), and a threaded rod connector (16.4), as shown in FIG. 4;
(c) the desalter entrance bushing (19) comprises an insulator of the desalter entrance bushing (19.1), a contact tip for the entrance bushing consisting of a threaded tip (19.2) with a housing for the installation of sealing rings and with threaded holes for the connection of the conductor rod of the entrance bushing (17.3) and the contact tip (17.4), where a locknut (17.5) is used to prevent loosening of the part during operation, as shown in FIG. 5;
d) the interconnection piping subset (18) comprises: a structure for installing the vertical section of the conductors (18.1); a rigid conductor transition crosshead (18.2); an insulating liquid reservoir and sight glass (18.3); a transition structure for the transformer flange (18.4); a structure for ventilation and pressure indicator connection (18.5); and a drainage structure (18.6).

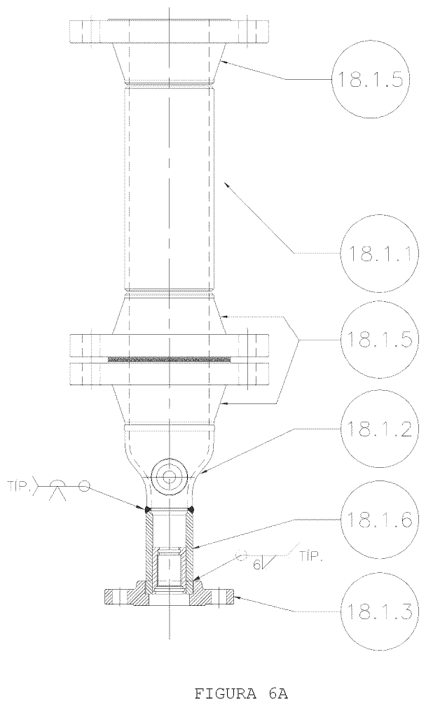

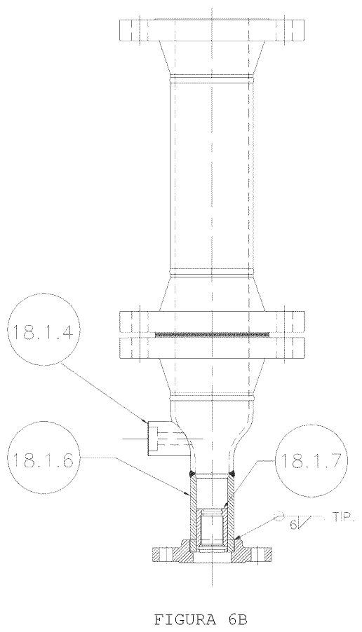

In this regard, the structure for installing the vertical section of the conductors (18.1) comprises: a 4″ pipeline (18.1.1); a flange for fixing to the desalter vessel (18.1.3); at least one 4″ flange (18.1.5); a 2″ tube (18.1.6); the fixing part of the entrance bushing with a thread (18.1.7); a sleeve for assembling the drainage structure (18.1.4); and a concentric reduction from 2″ to 4″ (18.1.2), as shown in FIGS. 6A and 6B.

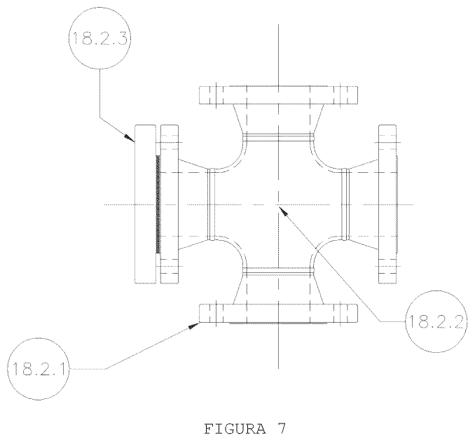

In addition, the rigid conductor transition crosshead (18.2) comprises: four flanges for system mounting (18.2.1); a crosshead for right-angle interconnection (18.2.2); and a blind flange (18.2.3), as shown in FIG. 7.

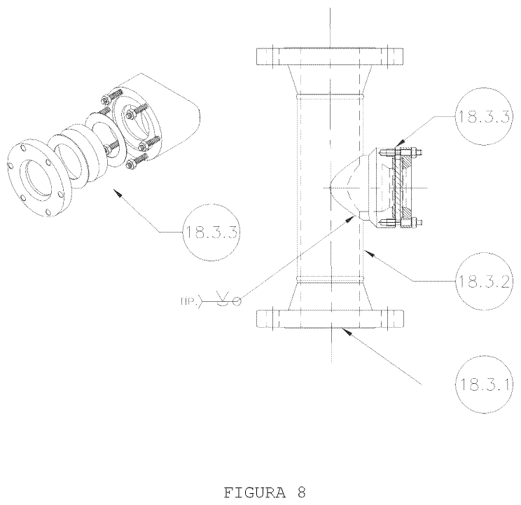

In turn, the sight glass (18.3) is composed of: two flanges for mounting the system (18.3.1); a tube for oil reservoir and installation of the sight glass (18.3.2); and an oil sight gauge (18.3.3), as shown in FIG. 8.

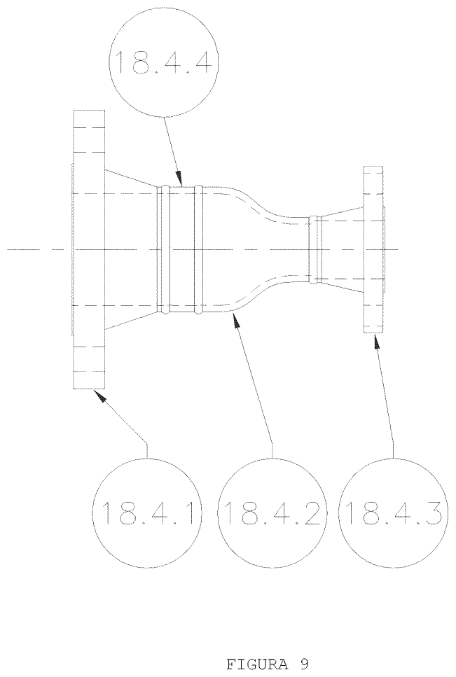

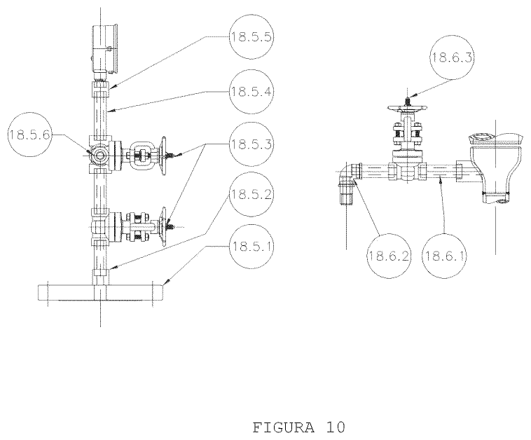

The transformer flange transition structure (18.4) features: a crosshead mounting flange (18.4.1); a concentric reduction (18.4.2); a transformer mounting flange (18.4.3); and one tube for clearance adjustment (18.4.4) % as shown in FIG. 9.

The structure for ventilation and connection of pressure indicator (18.5) comprises: a closure flange for the set (18.5.1); a sleeve for mounting the valves (18.5.2); two gate valves (18.5.3); five tubes for interconnecting the parts (18.5.4); a sleeve for pressure gauge connection (18.5.5); and a “T” type connection (18.5.6).

The drainage structure (18.6) comprises: three tubes for interconnecting the parts (18.6.1); an elbow connection (18.6.2); and a gate valve (18.6.3).

Based on the descriptions of the set, details of its operation will be provided below.

The desalter entrance bushing subset (17) is responsible for the electrical connection of the entrance bushing to the electrodes inside the desalter vessel through pressure contact in the plate-spring set that forms the electrode.

These parts of the desalter entrance bushing subset (17) are screw-mounted onto the desalter entrance bushing insulator using sealing rings to prevent the passage of material under the design operating condition.

The desalter entrance bushing subset insulator (17) has the tip at one of its ends with the rigid conductor (17.3), crossing it longitudinally through centralized drilling.

The other end of the desalter entrance bushing subset (17) of the desalter is screwed into the part that fixes the entrance bushing to the desalter vessel, which forms the structure for installing the vertical section of the conductors (18.1), and uses sealing rings to provide leak tightness under operating conditions.

The structure for installing the vertical section of the conductors (18.1), as shown in FIGS. 6A and 6B, consists of a flange for fixing to the desalter vessel (18.1.3), mounted on a 2″ tube section (18.1.6), where the entrance bushing fixing part with a thread (18.1.7) will be inserted by interference to fix the insulator (17.1) and provide housing for the placement of the sealing rings, and on the other end of the 2″ tube section (18.1.6), a concentric reduction from 2″ to 4″ (18.1.2) is welded, which transitions to a pipeline diameter that ensures the necessary insulation (compatible with the insulation level of the transformer secondary winding) for the rod immersed in insulating liquid at its center. For this, the entrance bushing insulator (17.1) must cover the entrance bushing tip conductor (17.3) up to the end of the diameter transition, and in this concentric reduction (18.1.2), a hole is made, and a sleeve (18.1.4) is welded to it, which is used for assembling the drainage structure (18.6).

The 4″ pipeline part (18.1.1) and 4″ flanges (18.1.5) function to adjust the vertical clearance of the set to the height of the center of the transformer bushing. The rigid conductor transition crosshead (18.2) allows for a right-angle connection between the vertical conductor rod (16.2) and the horizontal conductor rod (16.1) through the right-angle interconnection connector (16.5).

The use of the transition crosshead (18.2) and the designed interconnection connector allows for the assembly of the conductive elements, with the insertion of the horizontal rod, along with the pipeline set already assembled.

The horizontal conductor rod (16.1) is mounted centrally with the transformer flange transition structure (18.4) and with the transformer entrance bushing (15). In the transformer flange transition structure (18.4), the flange for fixing to the transition crosshead and the tube welded to it—parts (18.4.1) and (18.4.4), respectively—have a 4″ diameter to maintain the insulation clearance to the conductor immersed in insulating liquid.

The concentric reduction from 2″ to 4″ (18.4.2) is welded to (18. 4. 4), and the 2″ flange (18.4.3), also welded to this reduction, makes the transition to the pipeline diameter compatible with the transformer entrance bushing flange.

To ensure the insulation of the rod during the diameter reduction and as it passes through the flanges and parts of the transformer, the transformer entrance bushing insulator (15) was designed with a sufficient length to remain exposed outside the transformer, covering the horizontal conductor (16.1) throughout the diameter transition.

The transformer exit bushing insulator (15.1) maintained the same dimensions as the original bushing in the section that is inside the transformer, from the thread for its fixation in the transformer tank to the threaded connection piece (15.2) and the electrical connection to the transformer (15.3). The threaded connection piece (15.2) and the electrical connection to the transformer (15.3) were designed to allow the connection of the horizontal conductor (16.1) through a threaded connection, without the need to remove oil or open the transformer.

While aspects of this invention may be susceptible to various modifications and alternative forms, specific embodiments have been shown by way of example in the drawings and have been described in detail in this document. But it must be understood that the invention is not intended to be limited to the specific forms disclosed. Instead, the invention must cover all modifications, equivalents, and alternatives that fall within the scope of the invention, as defined by the following attached claims.

1. A set for replacement of entrance bushings of desalters in a flexible conductor with a bare rigid conductor immersed in an insulating liquid, the set comprising:
a transformer entrance bushing subset;
an interconnecting conductive parts subset;
a desalter entrance bushing subset; and
an interconnection piping subset.

2. The set of claim 1, wherein the transformer entrance bushing subsetcomprises:
an oil reservoir;
a pressure relief check valve;
an isolator of a transformer output bushing;
a threaded connection piece; and
an electrical connection to the a transformer.

3. The set of claim 1, wherein the interconnecting conductive parts subset comprises:
a horizontal electric conductor rod;
a vertical electric conductor rod;
a threaded rod connector; and
a right-angle interconnection connector,
wherein the threaded rod connector provides a mechanical interconnection and an electrical interconnection between sections of the vertical electric conductor rod, and and
wherein the right-angle interconnection connector connects the horizontal electric conductor rod and the vertical electric conductor rod.

4. The set of claim 1, wherein the desalter entrance bushing subset-comprises:
a desalter entrance bushing insulator;
at least two sealing rings; and
an entrance bushing contact tip, wherein the entrance bushing contact tip comprises:
a threaded tip with housing for the at least two sealing rings and threads for mounting the set;
an entrance bushing tip conductor;
a contact tip; and
a locknut configured to lock the a contact tip assembly.

5. The set of claim 1, wherein the interconnection piping subset-comprises:
a structure for installing a vertical section of the conductors;
a rigid conductor transition crosshead;
an insulating liquid reservoir and sight glass;
a transformer flange transition structure;
a structure for ventilation and connection of a pressure indicator; and
a drainage structure.

6. The set of claim 5, wherein the structure for installing the vertical section of the conductors comprises:
a 4″ pipeline;
a concentric reduction from 2″ to 4″;
a flange for fixing to a desalter vessel;
a sleeve for assembling the drainage structure;
at least one 4″ flange;
a 2″ tube; and
a threaded entrance bushing fixing part.

7. Set, according to claim 5, characterized in that The set of claim 5, wherein the rigid conductor transition crosshead comprises:
four flanges for system mounting;
a crosshead for a right-angle interconnection; and
a blind flange.

8. Set, according to claim 5, characterized in that The set of claim 5, wherein the insulating liquid reservoir and sight glass comprises:
two flanges for system mounting;
one tube for oil reservoir and installation of the sight glass; and
an oil sight gauge.

9. Set, according to claim 5, characterized in that The set of claim 5, wherein the transformer flange transition structure-comprises:
a crosshead mounting flange;
a concentric reduction;
a transformer mounting flange; and
a tube for clearance adjustment.

10. Set, according to claim 5, characterized in that The set of claim 5, wherein the structure for ventilation and connection of the pressure indicator comprises:
a closure flange for the set;
a sleeve for mounting valves;
two gate valves;
five tubes for interconnecting the parts;
a sleeve for pressure gauge connection; and
a “T” type connection.

11. Set, according to claim 5, characterized in that The set of claim 5, wherein the drainage structure comprises:
three tubes for interconnecting the parts;
an elbow connection; and
a gate valve.

12. The set of claim 6,
wherein the flange for fixing to the desalter vessel is mounted on a one end of the 2″ tube, wherein the threaded entrance bushing fixing part-is inserted by interference for fixing a desalter entrance bushing insulator and a housing for placing sealing rings.

13. The set of claim 12, wherein the concentric reduction from 2″ to 4″ is welded onto another end of the 2″ tube, which transitions to a pipeline diameter.

14. The set of claim 13, wherein the desalter entrance bushing insulator covers an entrance bushing tip conductor up to the end of the diameter transition.

15. The set of claim 7, wherein the rigid conductor transition crosshead allows for a right-angle connection between a vertical conductor rod and a horizontal conductor rod through a right-angle interconnection connector.

16. The set of claim 3, wherein the horizontal electric conductor rod is mounted centrally with a transformer flange transition structure and with the transformer entrance bushing subset.

17. The set of claim 9, wherein in the transformer flange transition structure, the crosshead mounting flange and the tube for clearance adjustment are welded together and have a 4″ diameter.

18. The set of claim 17,
wherein the concentric reduction is welded to the tube for clearance adjustment and to the transformer mounting flange, and
wherein the concentric reduction is from 2″ to 4″ and the transformer mounting flange is 2″.

19. The set of claim 3, wherein the transformer entrance bushing subset has a length sufficient to remain exposed outside the transformer, with a clearance that covers the horizontal electric conductor rod throughout the diameter transition.

20. The set of claim 2, wherein the threaded connection piece and the isolator of the transformer output bushing are configured to allow a connection of a horizontal electric conductor rod without a need to remove oil and open the transformer.
